(19) United States
(12) Patent Application Publication
(10) Pub. No.: US 2005/0138320 A1
(43) Pub. Date: Jun. 23, 2005

(54) Memory allocation unit

(76) Inventors: Shuichi Mitarai, Osaka-shi (JP); Tetsuji Yamamoto, Hirakata-shi (JP); Kazuomi Kato, Otsu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/012,191

(22) Filed: Dec. 16, 2004

(30) Foreign Application Priority Data
Dec. 19, 2003 (JP) 2003-422502(PAT.)

(51) Int. Cl. G06F 12/00

(52) U.S. Cl. 711/170

(57) ABSTRACT

A memory allocation unit is provided which initializes a memory when the memory is allocated, only if a program is judged unreliable. This memory allocation unit includes: a reliability decision section which decides whether a program is reliable, based on a predetermined decision criterion; a free-page pool section which manages a free page that is a page which can be allocated for the program; an initialization section which initializes the free page that is managed by the free-page pool section; and a page allocator section which receives a page request from the program, chooses a free page in the free-page pool section, requests the reliability decision section to decide whether the program is reliable and receives the result of a decision, and if the decision is made that the program is unreliable, requests the initialization section to initialize the chosen free page and allocates the initialized page for the program.

### BACKGROUND OF THE INVENTION

1. Field of the Invention;

The present invention relates to a memory allocation unit which is used for a computing system.

2. Description of the related art:

Conventionally, in a computer system which manages a memory by dividing it into page units, a program needs to get a memory. To do that, it requests an operating system to execute the allocation of pages. This is called a page request. An operating system manages pages, specifically, which pages can be allocated. These pages which can be allocated include pages which have never been used since the computer system started to operate, and pages which a program has returned to an operating system after they were used. Hereinafter, the former is referred to as an unused page, and the latter is referred to as a reusable page. When a page request is made, an operating system allocates reusable pages for programs. At that time, data which should be prevented from being exchanged between those programs may flow out. For example, in reusable pages, there are included password information or personal information which has just been used in a program. Or, the program's contents themselves are included. Hence, if such data leaks out to outsiders, it may be used for the wrong purposes. Therefore, the following method is considered as a means to prevent data from flowing out. When an operating system executes the allocation of pages, those pages are initialized using constants. In this method, however, the allocation of pages takes more time by such initialization. This makes a load on the system heavier, lowers the program's response performance, and causes other such issues. Aiming at resolving those issues, in the Linux operating system, when a page request is received, a judgment is made whether or not the data to be loaded onto that page is predetermined. Thereby, a decision is made whether or not the page should be initialized. Another invention is also presented to tackle the above described issues (refer to Japanese Unexamined Patent Publication No. 11-3271 specification). Specifically, the initialization of pages is executed all at once while a load stays light on the system. Thereby, when the allocation of pages takes place, those pages can be allocated without executing the initialization of pages.

However, as can be seen in the above described prior art, even if pages are initialized at a low system load, the more pages are initialized, the larger the system's throughput becomes. If a program which has requested a memory is given a reusable page, it can take a surreptitious glance at that page's data. Assuming that it does not, in the first place, there is no need for an operating system to initialize pages. However, in the prior art, pages are initialized on the assumption that all programs can stealthily look at them. As a result, unnecessary page initialization is executed, unless some programs are supposed to stealthily look at pages. Hence, such page initialization at the time of the allocation of pages is one of the factors which may lower a program's response performance, increase the whole system's throughput, or cause another such trouble. In addition, if pages are initialized, that prompts frequent replacement of data caches. This may lower a program's execution efficiency.

### DISCLOSURE OF THE INVENTION

In view of the above described conventional disadvantages, it is an object of the present invention to provide a page allocation unit which is capable of reducing the number of times at which pages are unnecessarily initialized.

In order to resolve the conventional disadvantages, a memory allocation unit according to the present invention, comprising: a reliability decision section which decides whether the program is reliable, based on a predetermined decision criterion; a free-page pool section which manages a free page, the free page being a page which is allocatable for the program; an initialization section which initializes the free page that is managed by the free-page pool section; and a page allocator section which receives a page request from the program, chooses a free page in the free-page pool section, requests the reliability decision section to decide whether the program is reliable and receives a decision, if the decision is made that the program is unreliable, requests the initialization section to initialize the chosen free page and allocates the initialized page for the program, in which the page is initialized at the time of the allocation of a memory, only if the decision is made that the program is unreliable.

In the memory allocation unit according to the present invention, when a reliable program requests pages, there is no need to initialize the pages. This reduces the number of times at which an operating system initializes the pages while being allocating the pages. In addition, the program which has been decided to be reliable is executed faster. Or, when pages are initialized, a large quantity of data caches can be prevented from being replaced. Thereby, in the following processing, the rate at which cache misses take place can be kept from becoming higher. Besides, the burden of processing which is executed by an operating system is reduced, thus heightening the execution efficiency and decreasing the power consumption.

These and other objects, features and advantages of the present invention will become more apparent upon reading of the following detailed description along with the accompanied drawings.

### BRIEF DESCRIPTION OF THE DRAWINGS

FIG. 1 is a block diagram, showing the configuration of a memory allocation unit according to a first embodiment of the present invention.

FIG. 2 is a flow chart, showing the procedure of processing in the memory allocation unit according to the first embodiment of the present invention.

FIG. 3 is a block diagram, showing the configuration of a memory allocation unit according to a second embodiment of the present invention.

FIG. 4 is a flow chart, showing the procedure of processing in the memory allocation unit according to the second embodiment of the present invention.

FIG. 5 is a block diagram, showing the configuration of a memory allocation unit according to a third embodiment of the present invention.

FIG. 6 is a flow chart, showing the procedure of processing in the memory allocation unit according to the third embodiment of the present invention.

FIG. 7 is a block diagram, showing the configuration of a memory allocation unit according to a fourth embodiment of the present invention.

FIG. 8 is a flow chart, showing the procedure of processing in the memory allocation unit according to the fourth embodiment of the present invention.

FIG. 9 is a block diagram, illustrating a means of providing a memory allocation program according to each embodiment of the present invention.

### DETAILED DESCRIPTION OF INVENTION

Hereinafter, embodiments of the present invention will be described with reference to the drawings.

### FIRST EMBODIMENT

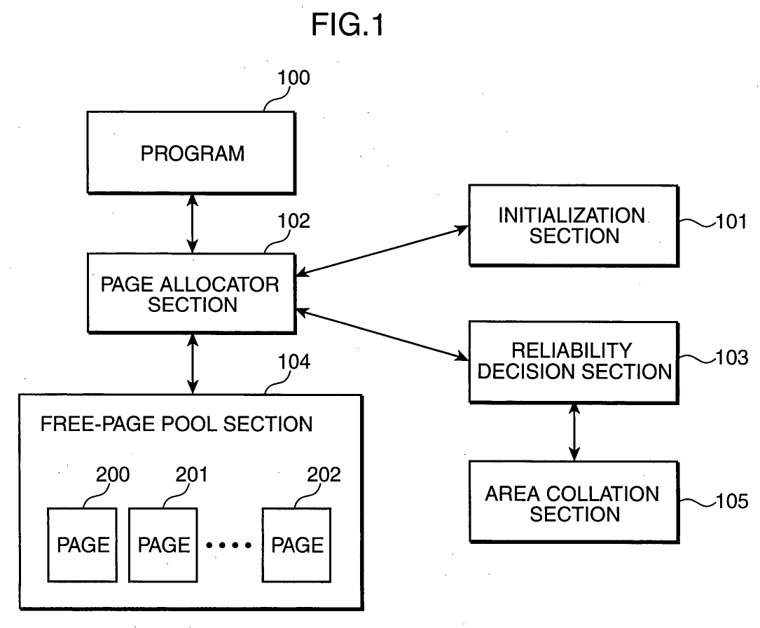

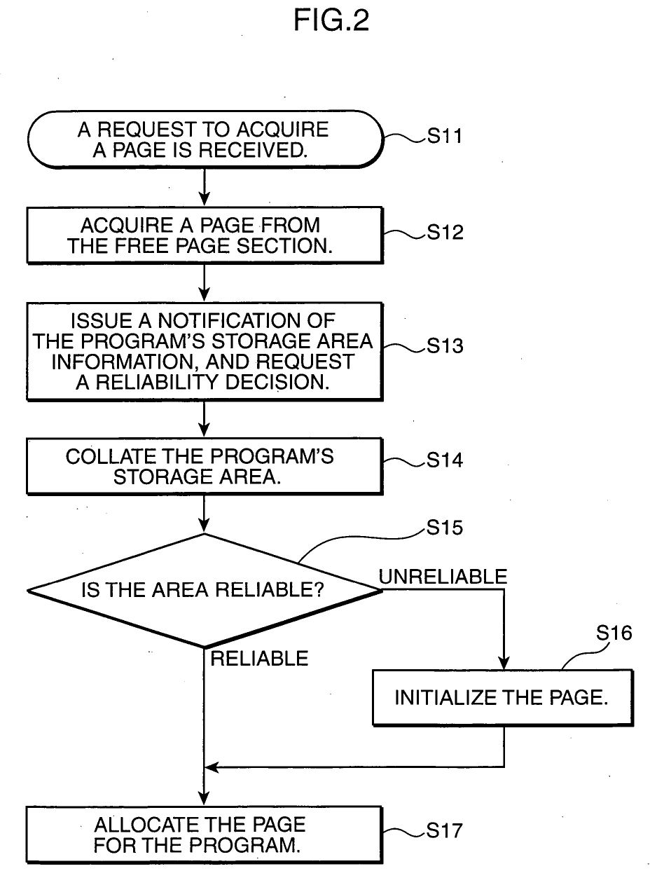

A first embodiment of the present invention will be described using FIG. 1 and FIG. 2.

FIG. 1 is a block diagram, showing the configuration of a memory allocation unit according to the first embodiment. A computer system is capable of dividing a memory into page units and managing them, and thereby, securing and releasing the memory into a page unit. A memory allocation unit in the computer system according to the present invention including: a program 100 which issues a page request so that the memory can be gotten; an area collation section 105 which decides whether an area where the program 100 is to be executed is registered in advance as reliable; a reliability decision section 103 which inquires of the area collation section 105 whether the program 100 is reliable, and then, decides that it is reliable if the area is registered beforehand, otherwise it is unreliable; a free-page pool section 104 which manages pages so as to deliver a usable page (i.e., an unused page or a reusable page) which can be newly allocated for the program 100; an initialization section 101 which initializes an unused page or a reusable page of the free-page pool section 104; and a page allocator section 102 which: receives a page request when the program 100 makes the page request; chooses a free page in the free-page pool section 104; with respect to the chosen free page, requests the reliability decision section 103 to decide whether the program 100 is reliable; if the decision is made by the reliability decision section 103 that the program 100 is reliable, allocates the free page as it is for the program 100, and on the other hand, if the decision is made that the program 100 is unreliable, requests the initialization section 101 to initialize the chosen free page and allocates the initialized page for the program 100.

The initialization section 101 receives an initialization request from the page allocator section 102, and then, it initializes the requested page. As an example, it initializes the page by writing a certain constant value in the whole page.

In the area collation section 105, there is registered, in advance, an area in which reliable programs are stored according to three parameters of a starting address, an ending address, and reliable/unreliable. First, it is notified by the reliability decision section 103 of a collation request and the starting address of an area in which the program 100 is stored. Then, the area collation section 105 collates them to confirm whether or not they have been executed within the area which is registered in the area collation section 105. The result which has been obtained by the collation is sent to the reliability decision section 103. Herein, a starting address, an ending address and reliability information are held. However, the present invention is not limited to this. The collation may also be executed with a starting address alone, without using an ending address. Besides, only a reliable area may also be registered. In that case, such a collation is executed by regarding areas which are not registered as unreliable.

The reliability decision section 103 receives a reliability decision request from the page allocator section 102. Then, it issues, to the area collation section 105, the starting address of an area in which the program 100 is stored and an area collation request. Thereby, it inquires whether or not the program 100 is registered in the area collation section 105. If the reliability decision section 103 is notified by the area collation section 105 that it is registered, it decides that the program 100 is reliable. On the other hand, if it is notified that it is not registered, it decides that it is unreliable. Then, it notifies the page allocator section 102 of the reliability decision result.

In the free-page pool section 104, there are stored pages (200, 201, 202) which are not used by any programs. When a page is allocated, the page allocator section 102 obtains the page from the free-page pool section 104. When a page is returned from a program, the page is returned through the page allocator section 102 to the free-page pool section 104.

The page allocator section 102 chooses a page to be allocated for the program 100 in the free-page pool section 104. Then, it issues a reliability decision request to the reliability decision section 103. If the reliability decision section 103 decides that it is reliable, it notifies the program 100 of the chosen page as it is. On the other hand, the reliability decision section 103 decides that it is unreliable, it transfers the chosen page to the initialization section 101. Then, it notifies the program 100 of the page after it has been initialized.

Herein, only the program 100 is described, however, a plurality of programs may also be provided. In addition, several programs can be simultaneously operated. Besides, a page request may also be made at the same time by each program.

Next, the procedure of processing according to this embodiment will be described using FIG. 2.

First, the program 100 issues a page request which demands a page allocation to the page allocator section 102 (in a step S11). This is to get a memory, in other words, to obtain a page.

Next, the page allocator section 102 accepts the page request from the program 100. Then, it chooses a free page in the free-page pool section 104, and obtains it (in a step S12).

The page allocator section 102 issues, to the reliability decision section 103, a reliability decision request which demands to decide whether the program 100 is reliable, and a starting physical address in which the program 100 is stored (in a step S13).

The reliability decision section 103 receives the reliability decision request and the starting physical address in which the program 100 is stored. Then, it notifies the area collation section 105 of an area collation request and the starting physical address in which the program 100 is stored. Next, it inquires whether the program 100 is executed within the registered area. Finally, it receives the result which has been produced by the area collation section 105 (in a step S14).

Based on the result it has received from the area collation section 105, the reliability decision section 103 decides whether the program 100 is reliable (in a step S15). If the area in which the program 100 is stored is registered in the area collation section 105, it decides that it is reliable (i.e., Reliable at the step S15). Then, it notifies the page allocator section 102 of the decision result. Sequentially, the page allocator section 102 allocates the page it obtained at the step S12, as it is, for the program 100 (in a step S17). On the other hand, if the area in which the program 100 is stored is not registered in the area collation section 105, it decides that it is unreliable (i.e., Unreliable at the step S15). Then, it requests the initialization section 101 to initialize the chosen free page, so that the initialization section 101 initializes the page (in a step S16). Next, the page allocator section 102 allocates, for the program 100, the initialized page it has received from the initialization section 101 (in the step S17).

Next, an example of the conditions for collation by the area collation section 105 according to the first embodiment of the present invention will be specifically described.

As a first example, there is considered a method of identifying a program according to which partition it has been executed from. For example, in embedded equipment, a program which is preinstalled in a product is usually stored in a read-only file system. Such a preinstalled program can be decided to be a reliable product. Hence, a program which is executed from the partition in which the preinstalled program is stored, can be judged reliable. On the other hand, a program which is executed from the other partitions, can be judged unreliable.

As a second example, the following method is mentioned. A record medium is originally attached to a product at the time when it is shipped from a factory. Such a record medium can be identified by a mapped physical address, using an operating system. Using this, a program which is executed from the record medium which is formed from the beginning at the time of the factory shipment, can be judged reliable. On the other hand, a program except that, for example, a program which is executed from within a network, or from within a storage device, can be judged unreliable.

As described above, a decision is made whether a program is reliable, based upon its storage area. If it is judged reliable, there is no need to initialize a memory when it is allocated. This makes the allocation faster, thereby heightening the execution efficiency in an operating system.

### SECOND EMBODIMENT

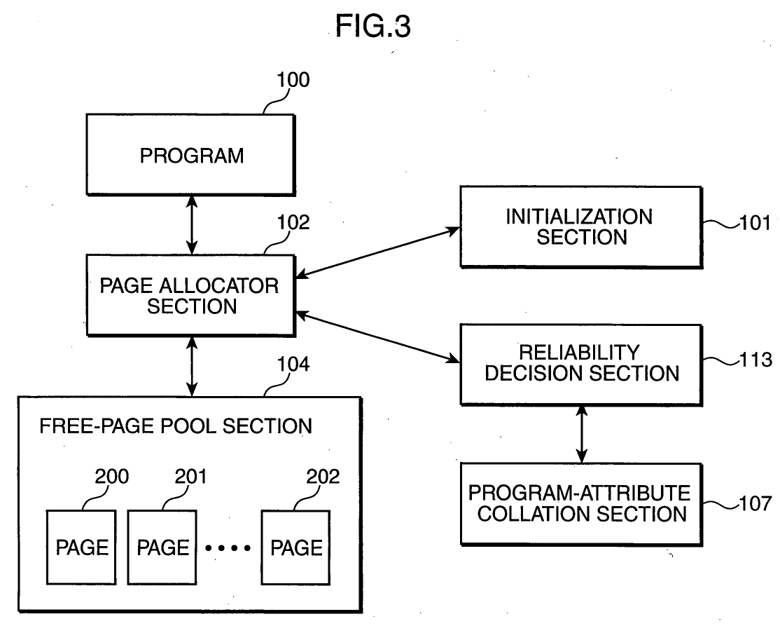

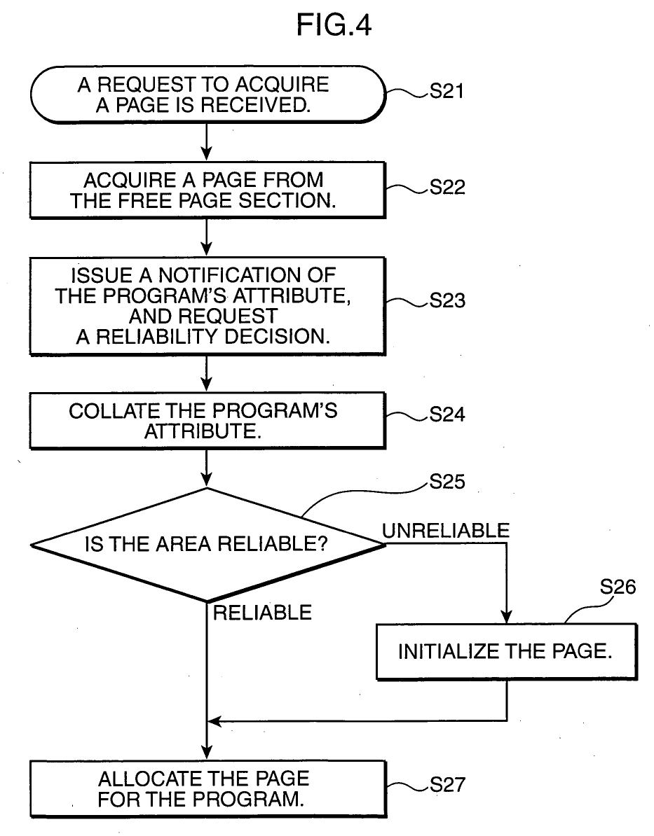

A second embodiment of the present invention will be described using FIG. 3 and FIG. 4.

FIG. 3 is a block diagram, showing the configuration of a memory allocation unit according to the second embodiment.

A computer system is capable of dividing a memory into page units and managing them, and thereby, securing and releasing the memory into a page unit. A memory allocation unit in the computer system according to the present invention including: a program 100 which issues a page request so that the memory can be gotten; a program-attribute collation section 107 which decides whether or not the attribute of a reliable program is registered; a reliability decision section 113 which inquires of the program-attribute collation section 107 whether the program 100 is reliable, and then, decides that it is reliable if the area is registered beforehand, otherwise it is unreliable; a free-page pool section 104 which manages pages so as to deliver a usable page (i.e., an unused page or a reusable page) which can be newly allocated for the program 100; an initialization section 101 which initializes the contents of an unused page or a reusable page of the free-page pool section 104; and a page allocator section 102 which: receives a page request when the program 100 makes the page request; chooses a free page in the free-page pool section 104; with respect to the chosen free page, requests the reliability decision section 113 to decide whether the program 100 is reliable; if the decision is made by the reliability decision section 113 that the program 100 is reliable, allocates the free page for the program 100, and on the other hand, if the decision is made that the program 100 is unreliable, allows the initialization section 101 to initialize the page and allocates the page for the program 100.

The initialization section 101 receives an initialization request from the page allocator section 102, and then, it initializes the requested page. As an example, it initializes the page by writing a certain constant value in the whole page.

In the program-attribute collation section 107, there is registered, in advance, the attribute of a reliable program according to two parameters of an attribute and reliable/unreliable. First, it is notified by the reliability decision section 113 of a collation request and a program attribute which represents the attribute of the program 100. Then, the program-attribute collation section 107 collates the attribute value to confirm whether or not it is registered in the program-attribute collation section 107. The result which has been obtained by the collation is sent to the reliability decision section 113. As an example, a user ID or a group ID of the UNIX® can also be used as the program attribute value. Herein, an attribute and reliability information are held. However, the present invention is not limited to this. Only a reliable attribute may also be registered. In that case, such a collation is executed by regarding attributes which are not registered as unreliable.

The reliability decision section 113 receives a reliability decision request from the page allocator section 102. Then, it issues, to the program-attribute collation section 107, the attribute of the program 100 and an attribute collation request. Thereby, it inquires whether or not the attribute of the program 100 is registered in the program-attribute collation section 107. If the reliability decision section 113 is notified by the program-attribute collation section 107 that it is registered, it decides that the program 100 is reliable. On the other hand, if it is notified that it is not registered, it decides that it is unreliable. Then, it notifies the page allocator section 102 of the reliability decision result.

In the free-page pool section 104, there are stored pages (200, 201, 202) which are not used by any programs. When a page is allocated, the page allocator section 102 obtains the page from the free-page pool section 104. When a page is returned from a program, the page is returned through the page allocator section 102 to the free-page pool section 104.

The page allocator section 102 chooses a page to be allocated for the program 100 in the free-page pool section 104. Then, it issues a reliability decision request to the reliability decision section 113. If the reliability decision section 113 decides that it is reliable, it notifies the program 100 of the chosen page as it is. On the other hand, the reliability decision section 113 decides that it is unreliable, it transfers the chosen page to the initialization section 101. Then, it notifies the program 100 of the page after it has been initialized.

Herein, only the program 100 is described, however, a plurality of programs may also be provided. In addition, several programs can be simultaneously operated. Besides, a page request may also be made at the same time by each program.

Next, the procedure of processing according to this embodiment will be described using FIG. 4.

First, the program 100 issues a page request which demands a page allocation to the page allocator section 102 (in a step S21). This is to get a memory, in other words, to obtain a page.

Next, the page allocator section 102 receives the page request from the program 100. Then, it chooses a free page in the free-page pool section 104, and obtains it (in a step S22).

The page allocator section 102 issues, to the reliability decision section 113, a reliability decision request which demands to decide whether the program 100 is reliable, and a program attribute which represents the attribute of the program 100 (in a step S23).

The reliability decision section 113 receives the reliability decision request and the program attribute which represents the attribute of the program 100. Then, it issues, to the program-attribute collation section 107, an attribute collation request and the program attribute of the program 100. Next, it inquires whether the attribute of the program 100 is registered. Finally, it receives the result which has been produced by the program-attribute collation section 107 (in a step S24).

Based on the result it has received from the program-attribute collation section 107, the reliability decision section 113 decides whether the program 100 is reliable (in a step S25). If the attribute of the program 100 is registered in the program-attribute collation section 107, it decides that it is reliable (i.e., Reliable at the step S25). Then, the reliability decision section 113 notifies the page allocator section 102 of the decision result. Sequentially, the page allocator section 102 allocates the page it obtained at the step S22, as it is, for the program 100, (in a step S27). On the other hand, if the attribute of the program 100 is not registered in the program-attribute collation section 107, it decides that it is unreliable (i.e., Unreliable at the step S25). Then, the reliability decision section 113 notifies the page allocator section 102 of the decision result. Sequentially, the page allocator section 102 requests the initialization section 101 to initialize the chosen free page, so that the initialization section 101 initializes the page (in a step S26). Next, the page allocator section 102 allocates, for the program 100, the initialized page it has received from the initialization section 101 (in the step S27).

As described above, a decision is made whether a program is reliable, based upon its attribute. If it is judged reliable, there is no need to initialize a memory when it is allocated. This makes the allocation faster, thereby heightening the execution efficiency in an operating system.

### THIRD EMBODIMENT

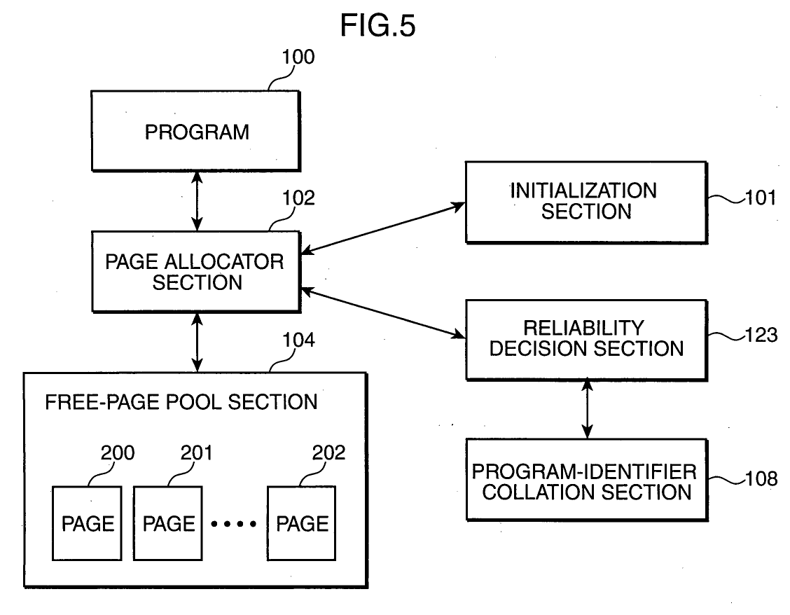

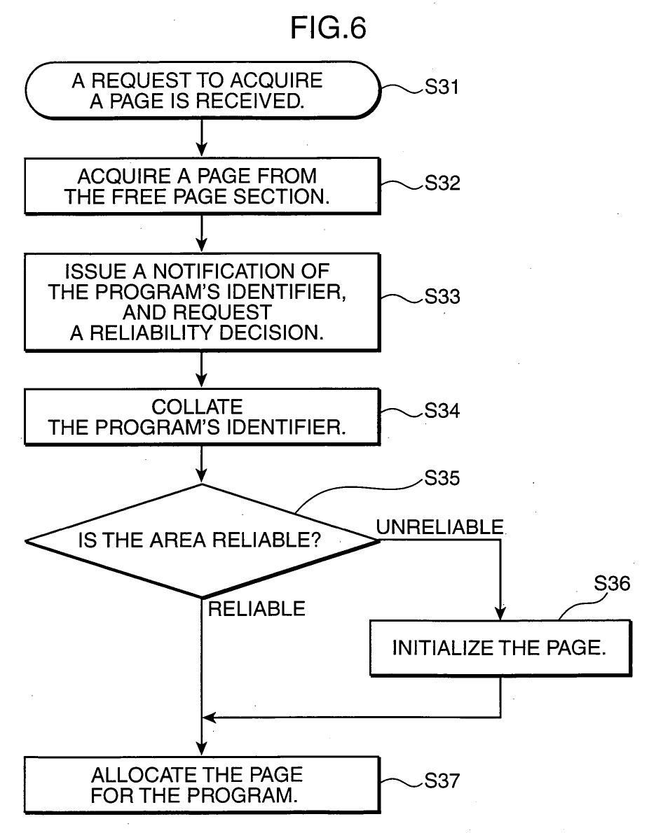

A third embodiment of the present invention will be described using FIG. 5 and FIG. 6.

FIG. 5 is a block diagram, showing the configuration of a memory allocation unit according to the third embodiment.

A computer system is capable of dividing a memory into page units and managing them, and thereby, securing and releasing the memory into a page unit. A memory allocation unit in the computer system including: a program 100 which issues a page request so that the memory can be gotten; a program-identifier collation section 108 which collates the identifier of a reliable program to confirm whether or not it is registered; a reliability decision section 123 which inquires of the program-identifier collation section 108 the identifier of the program 100, and then, decides that it is reliable if the identifier is registered beforehand in the program-identifier collation section 108, otherwise it is unreliable; a free-page pool section 104 which manages pages so as to deliver a usable page (i.e., an unused page or a reusable page) which can be newly allocated for the program 100; an initialization section 101 which initializes the contents of an unused page or a reusable page of the free-page pool section 104; and a page allocator section 102 which: receives a page request when the program 100 makes the page request; chooses a free page in the free-page pool section 104; with respect to the chosen free page, requests the reliability decision section 123 to decide whether the program 100 is reliable; if the decision is made by the reliability decision section 123 that the program 100 is reliable, allocates the free page for the program 100, and on the other hand, if the decision is made that the program 100 is unreliable, allows the initialization section 101 to initialize the page and allocates the page for the program 100.

The initialization section 101 receives an initialization request from the page allocator section 102, and then, it initializes the requested page. As an example, it initializes the page by writing a certain constant value in the whole page.

In the program-identifier collation section 108, there is registered, in advance, a reliable program according to two parameters of an identifier and reliable/unreliable. First, it is notified by the reliability decision section 123 of a reliability decision request and the identifier of the program 100. Then, the program-identifier collation section 108 collates the identifier to confirm whether or not it is registered in the program-identifier collation section 108. The result which has been obtained by the collation is sent to the reliability decision section 123. As an example, a PID of the UNIX® can also be used as the program identifier. Besides, a program's CRC checksum value may also be used as the program identifier. Herein, an identifier and reliability information are held. However, the present invention is not limited to this. Only a reliable identifier may also be registered. In that case, such a collation is executed by regarding identifiers which are not registered as unreliable.

The reliability decision section 123 receives a reliability decision request from the page allocator section 102. Then, it issues, to the program-identifier collation section 108, the identifier of the program 100 and an identifier collation request. Thereby, it inquires whether or not the identifier of the program 100 is registered in the program-identifier collation section 108. If the reliability decision section 123 is notified by the program-identifier collation section 108 that it is registered, it decides that the program 100 is reliable. On the other hand, if it is notified that it is not registered, it decides that it is unreliable. Then, it notifies the page allocator section 102 of the reliability decision result.

In the free-page pool section 104, there are stored pages (200, 201, 202) which are not used by any programs. When a page is allocated, the page allocator section 102 obtains the page from the free-page pool section 104. When a page is returned from a program, the page is returned through the page allocator section 102 to the free-page pool section 104.

The page allocator section 102 chooses a page to be allocated for the program 100 in the free-page pool section 104. Then, it issues a reliability decision request to the reliability decision section 123. If the reliability decision section 123 decides that it is reliable, it notifies the program 100 of the chosen page as it is. On the other hand, the reliability decision section 123 decides that it is unreliable, it transfers the chosen page to the initialization section 101. Then, it notifies the program 100 of the page after it has been initialized.

Herein, only the program 100 is described, however, a plurality of programs may also be provided. In addition, several programs can be simultaneously operated. Besides, a page request may also be made at the same time by each program.

Next, the procedure of processing according to this embodiment will be described using FIG. 6.

First, the program 100 issues a page request which demands a page allocation to the page allocator section 102 (in a step S31). This is to get a memory, in other words, to obtain a page.

Next, the page allocator section 102 receives the page request from the program 100. Then, it chooses a free page in the free-page pool section 104, and obtains it (in a step S32).

The page allocator section 102 issues, to the reliability decision section 123, a reliability decision request which demands to decide whether the program 100 is reliable, and the identifier of the program 100 (in a step S33).

The reliability decision section 123 receives the reliability decision request and the identifier of the program 100. Then, it issues, to the program-identifier collation section 108, an identifier collation request and the identifier of the program 100. Next, it inquires whether the identifier of the program 100 is registered. Finally, it receives the result which has been produced by the program-identifier collation section 108 (in a step S34).

Based on the result it has received from the program-identifier collation section 108, the reliability decision section 123 decides whether the program 100 is reliable (in a step S35). If the identifier of the program 100 is registered in the program-identifier collation section 108, it decides that it is reliable (i.e., Reliable at the step S35). Then, the reliability decision section 123 notifies the page allocator section 102 of the decision result. Sequentially, the page allocator section 102 allocates the page it obtained at the step S32, as it is, for the program 100, (in a step S37). On the other hand, if the identifier of the program 100 is not registered in the program-identifier collation section 108, it decides that it is unreliable (i.e., Unreliable at the step S35). Then, the reliability decision section 123 notifies the page allocator section 102 of the decision result. Sequentially, the page allocator section 102 requests the initialization section 101 to initialize the page which has been chosen at the step S32, so that the initialization section 101 initializes the page (in a step S36). Next, the page allocator section 102 allocates, for the program 100, the initialized page it has received from the initialization section 101 (in the step S37).

Next, an example of the conditions for collation by the program-identifier collation section 108 according to the third embodiment of the present invention will be specifically described.

As an example, inherent information (e.g., a file name and the offset information of a storage destination) which is used to identify a reliable program uniquely is defined in advance in the program-identifier collation section 108. When the program 100 requests a page, it inquires of the program-identifier collation section 108 whether or not the program 100 is registered. Its result is sent to the reliability decision section 123. Thereby, the program which is registered beforehand in the program-identifier collation section 108, can be judged reliable. In contrast, the other programs can be judged unreliable.

As described above, a decision is made whether a program is reliable, based upon its identifier. If it is judged reliable, there is no need to initialize a memory when it is allocated. This makes the allocation faster, thereby heightening the execution efficiency in an operating system.

### FOURTH EMBODIMENT

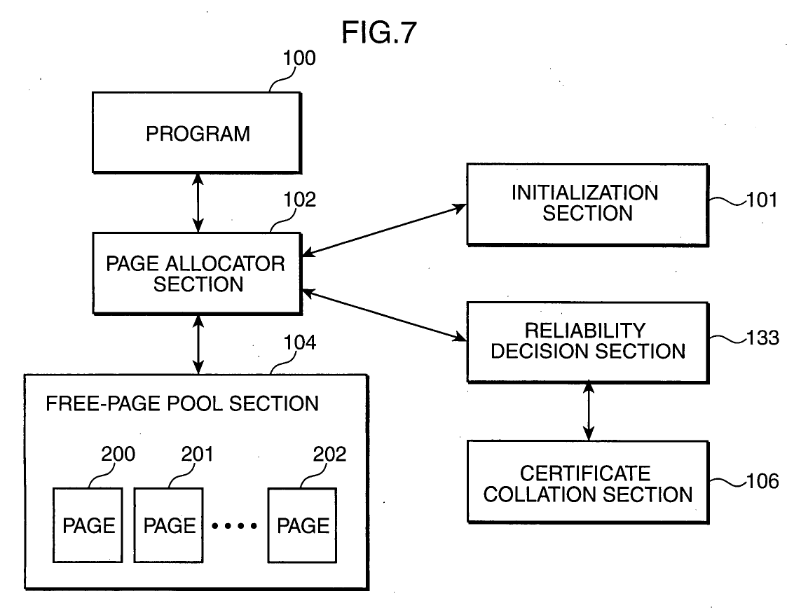

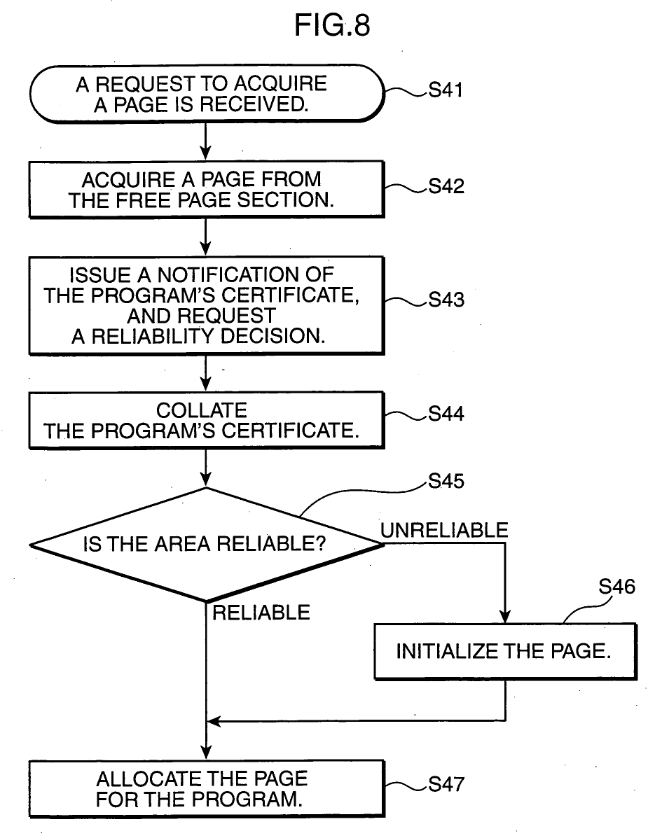

A fourth embodiment of the present invention will be described using FIG. 7 and FIG. 8.

FIG. 7 is a block diagram, showing the configuration of a memory allocation unit according to the fourth embodiment.

A computer system is capable of dividing a memory into page units and managing them, and thereby, securing and releasing the memory into a page unit. A memory allocation unit in the computer system including: a program 100 which issues a page request so that the memory can be gotten; a certificate collation section 106 which decides whether a certificate of the program 100 is genuine or counterfeit, the certificate being provided for every reliable program; a reliability decision section 133 which inquires of the certificate collation section 106 the certificate of the program 100, and then, decides that it is reliable if the certificate is registered beforehand, otherwise it is unreliable; a free-page pool section 104 which manages pages so as to deliver a usable page (i.e., an unused page or a reusable page) which can be newly allocated for the program 100; an initialization section 101 which initializes the contents of an unused page or a reusable page of the free-page pool section 104; and a page allocator section 102 which: receives a page request when the program 100 makes the page request; chooses a free page in the free-page pool section 104; with respect to the chosen free page, requests the reliability decision section 133 to decide whether the program 100 is reliable; if the decision is made by the reliability decision section 133 that the program 100 is reliable, allocates the free page for the program 100, and on the other hand, if the decision is made that the program 100 is unreliable, allows the initialization section 101 to initialize the page and allocates the page for the program 100.

The initialization section 101 receives an initialization request from the page allocator section 102, and then, it initializes the requested page. As an example, it initializes the page by writing a certain constant value in the whole page.

The certificate collation section 106 is notified by the reliability decision section 133 of a reliability decision request and the certificate of the program 100. Then, it decides whether the certificate is genuine or counterfeit, and notifies the reliability decision section 133 of its decision result.

The reliability decision section 133 receives a reliability decision request from the page allocator section 102. Then, it issues, to the certificate collation section 106, the certificate of the program 100 and a certificate collation request. Thereby, it inquires of the certificate collation section 106 whether the certificate of the program 100 is genuine or counterfeit. If the reliability decision section 133 is notified by the certificate collation section 106 that it is genuine, it decides that the program 100 is reliable. On the other hand, if it is notified that it is not genuine, it decides that it is unreliable. Then, it notifies the page allocator section 102 of the reliability decision result.

In the free-page pool section 104, there are stored pages (200, 201, 202) which are not used by any programs. When a page is allocated, the page allocator section 102 obtains the page from the free-page pool section 104. When a page is returned from a program, the page is returned through the page allocator section 102 to the free-page pool section 104.

The page allocator section 102 chooses a page to be allocated for the program 100 in the free-page pool section 104. Then, it issues a reliability decision request to the reliability decision section 133. If the reliability decision section 133 decides that it is reliable, it notifies the program 100 of the chosen page as it is. On the other hand, the reliability decision section 133 decides that it is unreliable, it transfers the chosen page to the initialization section 101. Then, it notifies the program 100 of the page after it has been initialized.

Herein, only the program 100 is described, however, a plurality of programs may also be provided. In addition, several programs can be simultaneously operated. Besides, a page request may also be made at the same time by each program.

Next, the procedure of processing according to this embodiment will be described using FIG. 8.

First, the program 100 issues a page request which demands a page allocation to the page allocator section 102 (in a step S41). This is to get a memory, in other words, to obtain a page.

Next, the page allocator section 102 receives the page request from the program 100. Then, it chooses a free page in the free-page pool section 104, and obtains it (in a step S42).

The page allocator section 102 issues, to the reliability decision section 133, a reliability decision request which demands to decide whether the program 100 is reliable, and the certificate of the program 100 (in a step S43).

The reliability decision section 133 receives the reliability decision request and the certificate of the program 100. Then, it issues, to the certificate collation section 106, a certificate collation request and the certificate of the program 100. Next, it inquires whether the certificate of the program 100 is genuine or counterfeit. Finally, it receives the result which has been produced by the certificate collation section 106 (in a step S44).

Based on the result it has received from the certificate collation section 106, the reliability decision section 133 decides whether the program 100 is reliable (in a step S45). If the certificate of the program 100 is judged genuine by the certificate collation section 106, it decides that it is reliable (i.e., Reliable at the step S45). Then, the reliability decision section 133 notifies the page allocator section 102 of the decision result. Sequentially, the page allocator section 102 allocates the page it obtained at the step S42, as it is, for the program 100, (in a step S47). On the other hand, if the certificate of the program 100 is judged not genuine by the certificate collation section 106, it decides that it is unreliable (i.e., Unreliable at the step S45). Then, the reliability decision section 133 notifies the page allocator section 102 of the decision result. Sequentially, the page allocator section 102 requests the initialization section 101 to initialize the page which has been chosen at the step S42, so that the initialization section 101 initializes the page (in a step S46). Next, the page allocator section 102 allocates, for the program 100, the initialized page it has received from the initialization section 101 (in the step S47).

As described above, a decision is made whether a program is reliable, based upon the result of a decision on whether its certificate is genuine or counterfeit. If it is judged reliable, there is no need to initialize a memory when it is allocated. This makes the allocation faster, thereby heightening the execution efficiency in an operating system.

Herein, in the memory allocation unit according to the present invention, whether or not a request to initialize a page should be given to the initialization section 101 can be determined by a program's reliability. However, a decision on whether it is reliable may also be made, not only by the certificate collation section 106, but also by a suitable combination of the corresponding sections which are mentioned in the above described embodiments. Specifically, the area collation section 105, the certificate collation section 106, the program-attribute collation section 107 and the program-identifier collation section 108 may also be properly combined.

(Memory Allocation Program and Program Product)

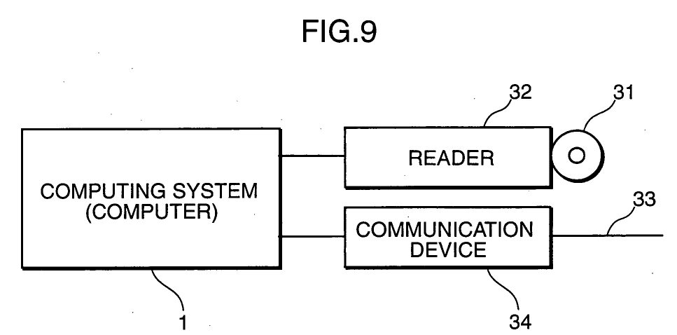

As shown in FIG. 9, a memory allocation program is read into a computing system 1 as a computer. Thereby, the computing system 1 functions as the memory allocation unit according to each embodiment. The memory allocation program can be provided via a record medium 31, such as an ROM, a flexible disk and a CD-ROM, or through a transmission medium 33, such as a telephone line and a network. In FIG. 9, a CD-ROM is shown as the record medium 31, and a telephone line is shown as the transmission medium 33. Such a memory allocation program includes a program in the narrow sense which is a group of commands to regulate the operational procedure of the computing system 1. In addition, it also includes data which is related to the operation of the computing system 1 according to that program.

A CD-ROM reader 32 as an external device is connected to the computing system 1. Thereby, the memory allocation program which is recorded in the CD-ROM as the record medium 31 can be read out. In addition, it can be stored in a storage device (not shown), such as an RAM and a hard disk, which is provided in the computing system 1. In the case where such a program is provided in the form of an ROM as the record medium 31, the ROM is mounted in the computing system 1. This allows the computing system 1 to execute the processing according to the memory allocation program.

The memory allocation program which is provided through the transmission medium 33 is received via a communication device 34. Then, the program is stored in a storage device (not shown), such as an RAM and a hard disk, which is provided in the computing system 1. The transmission medium 33 is not limited to a wired transmission medium. It may also be a wireless transmission medium. In addition, the transmission medium 33 includes not only a communication line, but also a relay device which relays a communication line. As such a relay device, for example, there is mentioned a communication link such as a router.

The memory allocation unit according to the present invention has an advantage in that only if a program is unreliable, a memory can be initialized when it is allocated. Therefore, it is useful for an embedded operating system or another such system which needs security. In addition, an operating system which is provided with the memory allocation unit according to the present invention can be used for a general-purpose computer product such as a personal computer, as well as for various household electrical appliances, information processing equipment, cellular phones, industrial equipment and the like, which are provided with a computer.

This application is based on Japanese patent application serial No. 2003-422502, filed in Japan Patent Office on Dec. 19, 2003, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

1. A memory allocation unit which manages a memory in a page unit, and gets and releases the memory according to a request that is made by a program, comprising:
a reliability decision section which decides whether the program is reliable, based on a predetermined decision criterion;
a free-page pool section which manages a free page, the free page being a page which is allocatable for the program; an initialization section which initializes the free page that is managed by the free-page pool section; and
a page allocator section which: receives a page request from the program; chooses a free page in the free-page pool section; requests the reliability decision section to decide whether the program is reliable and receives a decision; and if the decision is made that the program is unreliable, requests the initialization section to initialize the chosen free page and allocates the initialized page for the program.

2. The memory allocation unit according to claim 1, wherein if the decision is made that the program is reliable, the page allocator section allocates the free page for the program, without requesting the initialization section to initialize the free page.

3. The memory allocation unit according to claim 1, further comprising an area collation section which manages a storage area that stores a reliable program, one or more storage areas each of which stores a program being provided,
wherein, if a program makes a page request, the reliability decision section decides whether the program which makes the page request is reliable, based on a storage area that stores the program which makes the page request and on information managed by the area collation section.

4. The memory allocation unit according to claim 1, further comprising a program-attribute collation section which manages an execution authorization attribute of a reliable program,
wherein, if a program makes a page request, the reliability decision section decides whether the program which makes the page request is reliable, based on an attribute of the program which makes the page request and on information managed by the program-attribute collation section.

5. The memory allocation unit according to claim 1, further comprising a program-identifier collation section which manages an identifier of a reliable program, the identifier being used for a system to identify a program uniquely,
wherein, if a program makes a page request, the reliability decision section decides whether the program which makes the page request is reliable, based on an identifier of the program which makes the page request and on information managed by the program-identifier collation section.

6. The memory allocation unit according to claim 1, further comprising a certificate collation section which decides whether a certificate of a program is genuine or counterfeit, the certificate being provided for every reliable program,
wherein, if a program makes a page request, the reliability decision section decides whether the program which makes the page request is reliable, based on a decision made by the certificate collation section on a certificate of the program which makes the page request.

7. A memory allocation method which manages a memory in a page unit, and gets and releases the memory according to a request that is made by a program, comprising:
a receiving step of receiving a page request from the program;
a choosing step of choosing a free page, the free page being a page which is allocatable for the program;
a deciding step of deciding whether the program is reliable, based on a predetermined decision criterion;
an initializing step of, if the decision is made that the program is unreliable in the deciding step, initializing the free page which is chosen in the choosing step; and
a page allocating step of, if the decision is made that the program is unreliable in the deciding step, allocating, for the program, the free page which is initialized in the initializing step, and if the decision is made that the program is reliable in the deciding step, allocating, for the program, the free page which is chosen in the choosing step.

8. A program product which is used to manage a memory in a page unit, and get and release the memory according to a request that is made by a program, comprising:
a memory allocation program which causes a computer to function as,
a reliability decision section which decides whether the program is reliable, based on a predetermined decision criterion,
a free-page pool section which manages a free page, the free page being a page which is allocatable for the program, an initialization section which initializes the free page that is managed by the free-page pool section, and
a page allocator section which receives a page request from the program, chooses a free page in the free-page pool section, requests the reliability decision section to decide whether the program is reliable and receives a decision, and if the decision is made that the program is unreliable, requests the initialization section to initialize the chosen free page, and allocates the initialized page for the program; and
a signal holding medium which holds the memory allocation program.

9. The program product according to claim 8, wherein the signal holding medium is at least one of a record medium and a transmission medium.

10. A program product which is used to manage a memory in a page unit, and get and release the memory according to a request that is made by a program, comprising:
a memory allocation program which causes a computer to execute,
a receiving step of receiving a page request from the program;
a choosing step of choosing a free page, the free page being a page which is allocatable for the program;
a deciding step of deciding whether the program is reliable, based on a predetermined decision criterion;
an initializing step of, if the decision is made that the program is unreliable in the deciding step, initializing the free page which is chosen in the choosing step; and
a page allocating step of, if the decision is made that the program is unreliable in the deciding step, allocating, for the program, the free page which is initialized in the initializing step, and if the decision is made that the program is reliable in the deciding step, allocating, for the program, the free page which is chosen in the choosing step; and
a signal holding medium which holds the memory allocation program.

11. The program product according to claim 10, wherein the signal holding medium is at least one of a record medium and a transmission medium.
